(19) United States
(12) Patent Application Publication
(10) Pub. No.: US 2012/0233542 A1
(43) Pub. Date: Sep. 13, 2012

(54) DEFECT REVIEW SUPPORT DEVICE, DEFECT REVIEW DEVICE AND INSPECTION SUPPORT DEVICE

(75) Inventor: Tomohiro Funakoshi, Hitachinaka (JP)

(73) Assignee: Hitachi High-Technologies Corporation

(21) Appl. No.: 13/391,313

(22) PCT Filed: Jun. 23, 2010
(86) PCT No.: PCT/JP2010/004160

§ 371 Date: May 10, 2012

(30) Foreign Application Priority Data
Sep. 11, 2009 (JP) 2009-209923

(51) Int. Cl. G06F 17/00

(52) U.S. Cl. 715/243

(57) ABSTRACT

To reduce the time taken to prepare a defect review report and to thereby improve the convenience of a defect review device or for an inspection system user. The above object is attained by implementing a review report preparation tool having a function to edit the layout of a review report in a data processing terminal.

### TECHNICAL FIELD

The present invention relates to an operation for checking the appearance of a product or a component part in the course of manufacture and, more particularly, to a data processing device, an inspection operation support system and a data processing method for supporting an operation to determine conditions for a device for detecting foreign materials and pattern defects on a surface of a semiconductor wafer, a photomask, a magnetic disk, a liquid crystal substrate, or the like, and an observation device for observing defects including foreign materials, as well as an analysis operation to check the performances of the devices.

### BACKGROUND ART

In a process of manufacturing a semiconductor device, a liquid crystal device or a magnetic disk, a foreign material or a pattern defect on a surface of a semiconductor wafer or a liquid crystal substrate is a cause of a product fault. There is, therefore, a need to continuously monitor whether or not there is any problem with the manufacturing apparatus and the manufacture environment by quantifying foreign materials and pattern defects (hereinafter referred to as appearance faults). There is also a need to check whether or not such an appearance fault has a fatal influence on the product.

In recent years, defects have become smaller in size with the reduction in processed size of semiconductor devices. In recent years, therefore, it has become a common practice to perform, for monitoring of defects such as described above, divided processes with a special-purpose device for detecting the positions of defects on a wafer and a special-purpose device for classifying defects by obtaining a high-magnification images at detected defect positions. As a device for detecting defect positions, an appearance inspection device such as an optical detection device or an inspection SEM is used. As a device for obtaining a high-magnification image at a defect position, a defect review SEM using a scanning electron microscope is used.

When a defect review SEM was first introduced as a defect observation tool, an operator manually performed the above-described defect classifying operation. There was, therefore, a problem that different persons who observe do not evenly recognize defect positions on observed objects and kinds of defect and do not stably recognize defects to be observed. Recently, to solve this problem, introduction of techniques for automatic defect review (ADR) and automatic defect classification (ADC) in which devices automatically determine the sizes, shapes, kinds, and so on of defects by using image processing techniques has begun. Results of ADR and ADC are displayed on a screen in such a manner as to be easily seen with the human eye and are finally output as a review report in a form on paper, a PDF file format, or the like.

On the other hand, semiconductor device and liquid crystal substrate manufacturers who are users of a defect review device have interest in how what kind of defect is distributed on a wafer or a liquid crystal substrate. This is because a distribution of defects on a wafer or a liquid crystal substrate relates to the processes of manufacturing the above-described various devices, and because each of the manufacturers adjusts conditions for the manufacturing process based on information on variations in a defect distribution. Therefore, a review report is ordinarily made in a form such that a defect map in which defect positions on a wafer or a liquid crystal substrate are shown on a schematic view of the wafer or the liquid crystal substrate and high-magnification images at representative points on the defect distribution shown by the defect map are displayed on one on-screen view.

JP Patent Publication (Kokai) No. 2008-130966 A (Patent Literature 1) discloses an example of a view for display of review results. Patent Literature 1 discloses a review report view provided in a form such that high-magnification images of defects shown in a defect map are displayed in thumbnail form in order of defect IDs on one view together with the defect map. The high-magnification images are displayed in thumbnail form along with a scroll bar, and a device user can read on a review result check view the thumbnail images at the defect positions with respect to all the IDs by operating the scroll bar.

JP Patent Publication (Kokai) No. 2007-232480 A (Patent Literature 2) discloses an example of a defect review device arranged so that a review report finally made can be freely edited on a report editing view. In the defect review device disclosed in Patent Literature 2, constituent elements of a report are combined into modules to be displayed as icons on the editing view. The defect review device is arranged so that the review report can be edited by displaying these icons in the editing view for a GUI. Once editing of a review report is completed, the review report is stored as a template. After the completion of the next defect review, a device operator can call up the stored template and output a review report in the same format.

### CITATION LIST

### Patent Literature

Patent Literature 1: JP Patent Publication (Kokai) No. 2008-130966 A

Patent Literature 2: JP Patent Publication (Kokai) No. 2007-232480 A

### SUMMARY OF INVENTION

### Technical Problem

In improving the yield in manufacture of a semiconductor device, a liquid crystal device or a magnetic disk, an operation to detect defects such as appearance faults, attached foreign materials or electrical defects is very important, as described above. Therefore an improvement in performance with the miniaturization of semiconductor devices is continually required of inspection devices, and inspection devices capable of detecting finer defects with high sensitivity have come on the market.

With the improvement in sensitivity of inspection devices, the amounts of information output from appearance inspection devices and defect observation devices have become enormously large. On the other hand, there is a need to finally compile inspection results in the form of a review report. Information output from an appearance inspection device or a defect observation device includes information on inspection results, such as detected foreign materials, the number of defects and defect feature quantities. There is a problem that a considerably long time is required for data processing and data rearrangement. “Data processing” referred to here means checking a plurality of groups of coordinate data output from a defect inspection device, taking in corresponding image data from a review device, inputting category numbers for kinds of defect, and performing Venn diagram analysis (adder-missing analysis). Also, “data rearrangement” means an operation including showing the correspondence between a defect map, defect positions on the map and images, for example, with presentation software sold on the market, and drawing a graph of the number of detections with respect to each of kind-of-defect categories.

Preparation of a review report requires selecting necessary images from a large number of image data items output from a defect observation device, and combining the images into one slide. With the improvement in performance of the defect observation devices, the amounts of image data output from the devices have become enormously large, and it has become more difficult to perform processing relating selection of images automatically output. The fact is that preparation of a review report is presently dependent on manual operations. Operations for searching for desired defects in such an enormous amount of image data, making checks against a defect map and combining data into a file require much expense in time. Therefore, there has been a demand for a support tool capable of easily preparing a review report.

Defects detected by defect review change between batches of inspection data. It is, therefore, difficult to fix in advance the relationships between dots on a defect map and images in the form of templates. Also, a situation may occur frequently in which a demand arises for changing the display format of a review report in course of preparation of the review report. In such a case, with a template-type review report format such as that described in Patent Literature 2, it is necessary to repeat a process including editing a template by returning to a template editing view, displaying the results of execution of the template on another view, and checking whether or not a review report is displayed in the desired format. After all, under the present circumstances, a review report is prepared according to inspection results by manual operations taking a long time.

Therefore, the present invention presents a defect review support device, a defect review device or an inspection support device capable of providing review report preparation functions improved in operability and easy to use.

### Solution to Problem

According to the present invention, the above-described problem is solved by implementing a review report preparation tool having a function to edit a layout of a review report in the above-described defect review support device, defect review device or inspection support device. A device user prepares a review report by calling up the above-described review report preparation tool on a monitor connected to each of the above-described devices. If there is a need to change the format of the review report, changing processing is executed on the review report preparation tool. All of a sequence of operations necessary for changing the format are executed on a GUI. An on-screen display of the review report preparation tool at the time of completion of review report preparation is a review report. If the device user outputs the on-screen display of the review report preparation tool at the time of completion of review report preparation, the output result itself is a review report.

When configured as hardware, the review report preparation tool is constituted by a storage means in which software for realizing the above-described function to edit the layout of the review report is stored, a computation means for executing this software, and a communication interface for transmitting a demand for data to an external database in which data necessary for review report preparation is stored. In correspondence with an operation performed on the GUI, the above-described computation means transmits a command to demand the necessary data to the above-described database, extracts the necessary data from a returned reply, and displays the data on the review report preparation tool. Thus, execution of the sequence of operations necessary for changing the format on the GUI is enabled.

Advantageous Effects of Invention

According to the present invention, a method of displaying a large amount of images and a defect map is devised to provide a means that makes checking of a large amount of images easier, and improves the facility with which a defect review report having a defect map and a defect images disposed around the defect map is prepared while check is made as to whether or not desired defects are detected. Also, means for enabling a report to be easily prepared with a freely designed layout, such as defect map enlarging/reducing display and image list display, are provided to realize an environment in which the above-described review report can be prepared in a markedly short time, which effect is unimaginable from the conventional art. Further, the time required to feedback defect inspections to the processes of manufacturing various devices is reduced. This effect contributes to an improvement in yield in manufacture of various devices.

### BRIEF DESCRIPTION OF THE DRAWINGS

FIG. 1 is an overall view showing. a configuration of a review support device in Embodiment 1 in a semiconductor device manufacturing process.

FIG. 2 shows an example of a format of defect information transmitted and received between an appearance inspection device, a review device and a defect review support device.

FIG. 3 shows an example of a construction of a data table stored in a database.

FIG. 4 shows an example of a review report finally prepared in Embodiment 1.

FIG. 5 shows a defect image checking view displayed on the review support device in Embodiment 1.

FIG. 6 shows an initial view displayed in a review report editing view in Embodiment 1.

FIG. 7 shows the review report editing view when a first thumbnail image is displayed.

FIG. 8 shows the review report editing view in a state where a thumbnail image changing pull-down menu is displayed.

FIG. 9 is a view for changing the contents of the thumbnail image changing pull-down menu.

FIG. 10 shows the review report editing view in a state where the thumbnail image changing pull-down is displayed after it is changed.

FIG. 11 shows the review report editing view immediately before a review report is completed.

FIG. 12 shows the review report editing view in a state where a display information changing and layout editing pull-down menu is displayed.

FIG. 13 shows the review report editing view in a state where a number-of-thumbnail-image changing pull-down menu.

FIG. 14 shows the review report editing view after the number thumbnail images is changed.

FIG. 15 is a diagram showing an internal configuration of the review support device in Embodiment 1.

FIG. 16 is a diagram showing the effects of the review support device in Embodiment 1.

FIG. 17 is an overall view showing a configuration of a review support device in Embodiment 2.

FIG. 18 is a diagram showing a basic operation on a review report editing view in Embodiment 2.

FIG. 19 is a diagram 2 showing a basic operation on the review report editing view in Embodiment 2.

FIG. 20 shows the review report editing view in a state where an enlarged view of a defect map is displayed.

FIG. 21 shows the review report editing view in a state where an image list is displayed in place of the defect map.

FIG. 22 shows a filtering window in Embodiment 2.

FIG. 23 shows an image enlarging display and kind-of-defect code input window.

FIG. 24 shows an internal configuration diagram of a defect review apparatus including a template-type review report generation function.

### DESCRIPTION OF EMBODIMENTS

Description will be made of embodiments with reference to the drawings.

### Embodiment 1

The present embodiment will be described with respect to an example of a configuration of a defect review support device that realizes functions for preparing a review report on a GUI by designating defect IDs. In the present embodiment, it is assumed that the defect review support device is applied to a semiconductor device manufacture line.

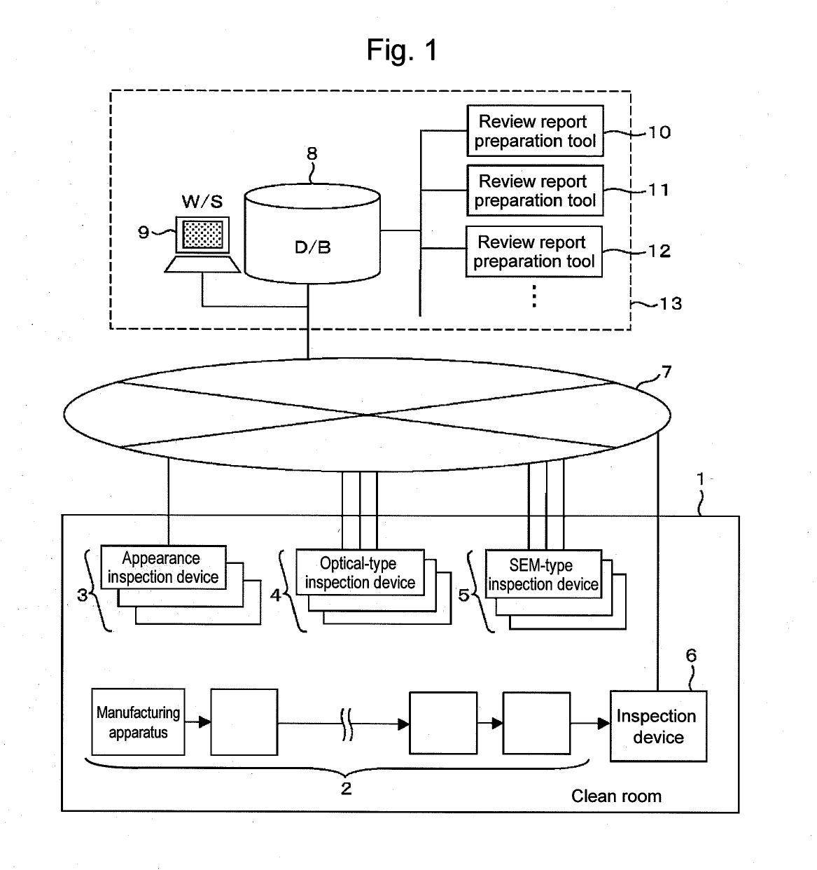

FIG. 1 shows an entire view of the configuration of the semiconductor device manufacture line. The semiconductor device manufacture line is ordinarily constituted by a plurality of manufacturing apparatuses 2 installed in a clean room 1. A semiconductor device is manufactured by forming a plurality of layers on a silicon substrate. Therefore an inspection is executed with respect to each of manufacturing processes for the layers. In ordinary cases, each of inspections: appearance inspection, optical defect review and SEM defect review is executed each time one of the manufacturing processes for the layers is completed. The number of devices used for each inspection is not limited to one. In many cases, a plurality of inspection devices: a group of appearance inspection devices 3, a group of optical-type defect review 4 and a group of SEM-type defect review devices 5 are used. The semiconductor device finally completed undergoes device characteristic inspection performed by the inspection device 6 and is thereafter sent to a dicing process for cutting out chips.

The appearance inspection device is a device for roughly checking the entire surface of a wafer to obtain information on positions on a wafer indicating defect candidates. The optical-type defect review device is a device for detecting foreign materials attached to a wafer and faults in wiring patterns formed on the wafer surface by obtaining optical images at defect candidate positions found by appearance inspection, and for classifying defects with respect to each kind of defect. The SEM-type defect review device is a device for detecting small defects and electrical defects (VC defects) that cannot be detected by the optical-type defect review, by using SEM images at defect candidate positions found by appearance inspection, and for classifying defects with respect to each kind of defect. The SEM-type defect review device can obtain not only a simple secondary electron image but also a plurality of backscattered electron images (shadow images) detected from different positions with respect to a primary electron beam optical axis. The above-described devices are connected to each other via a communication network 7.

A defect inspection support device 13 in the present embodiment is constituted by a database 8 for storing defect images detected by the optical-type defect review device and the SEM-type defect review device, a workstation 9 for storing in the database only image data desired by an inspection device user by removing unnecessary data from the image data output from the optical-type defect review device and the SEM-type defect review device, and terminals 10 to 12 in which a review report preparation tool is installed. While an example of a configuration in which a plurality of terminals are connected to the database 8 is shown in FIG. 1, only one terminal may suffice. A case is conceivable in which only either optical-type review devices or SEM-type review devices are connected as inspection devices or observation devices to the communication network 7. In such a case, the defect inspection support device 13 is called a review support device. The defect inspection support device in the present embodiment is connected to each of the inspection devices: the group of appearance inspection devices 3, the group of optical-type defect review 4 and the group of SEM-type defect review devices 5 via the communication network 7. Since the amount of defect information output from the group of appearance inspection devices 3 is enormously large, the workstation 9 also functions as a means for extracting defect position information to be used by the group of optical-type defect review devices 4 or the group of SEM-type defect review devices 5 or other defect information from the information output from the group of appearance inspection devices 3 by its filtering function. The extracted defect position information and other defect information are transmitted to the group of optical-type review devices 4 or the group of SEM-type defect review devices 5, and defect review is executed.

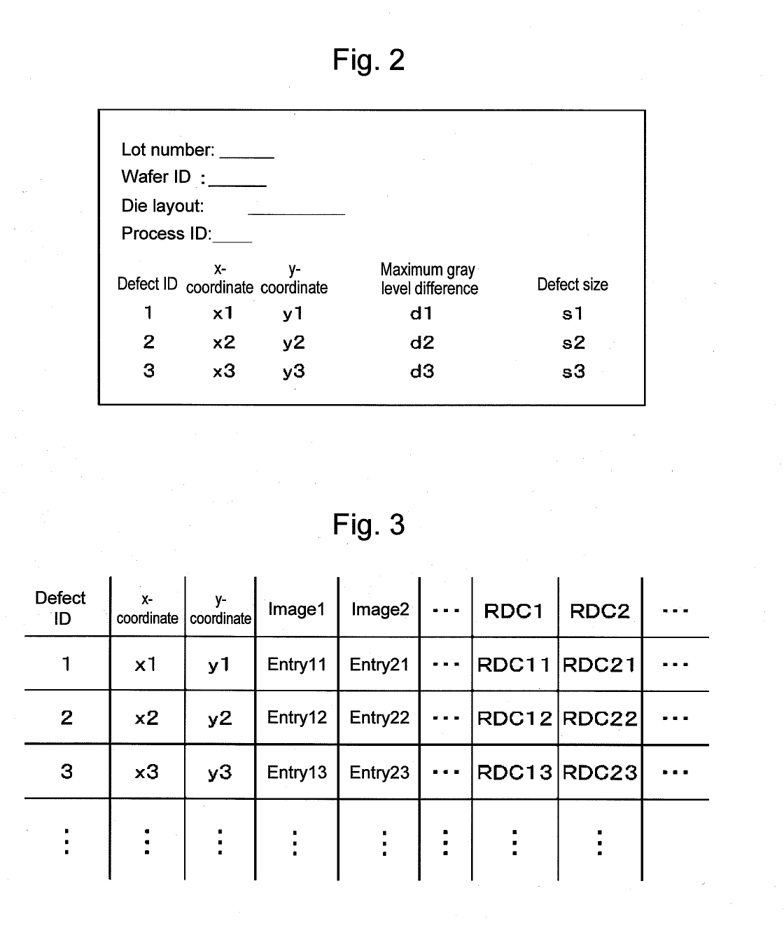

It is necessary that inspection information transmitted and received between the above-described groups of inspection devices, database 8 and workstation 9 be exchanged in a common format for mutual use. FIG. 2 shows an example of an inspection information format mutually usable between the plurality of inspection devices. Because wafers to be obtained as a product are flowed on a lot-by-lot basis in the semiconductor manufacturing process, the inspection information format includes a lot number, an ID for each of a plurality of wafers included in a lot and information on a layout of dies formed in the wafer. IDs are respectively assigned to detected defects. These IDs are also assigned to defect candidates detected when appearance inspection is executed. Any management of inspection information to be thereafter performed is performed by using these Ds as a key. Roughly speaking, defect information is constituted of information on coordinates for defect positions, data on defect images taken by any of the inspection devices, and defect feature quantity information (real-time defect classification (RDC) information) indicating attributes of defects. Examples of RDC information are a maximum gray level difference, a reference image average gray level, a defect image average gray level, polarity, an inspection mode, a defect size, the number of defect pixels, a defect size width, a defect size height, a defect size ratio, an in-defect-image defect portion pixel derivative, an in-reference-image defect pixel derivative, and information on kinds of defect. This data is transmitted in the format shown in FIG. 2 by means of text data together with other defect information.

In these examples, the maximum gray level difference is the absolute value of brightness of a defect portion when a differential image is obtained by processing an image in a place determined as a defect and an image of a corresponding reference portion. The reference image average gray level is the average of the brightness of a pixel portion determined as the defect portion, as seen on the reference image. The defect image average gray level is the average of the brightness of the pixel portion determined as the defect portion, as seen on the defect image. The polarity indicates whether the defect portion is bright or dark in comparison with the reference image. In the polarity, “+” indicates a light defect, while “−” indicates a dark defect. The inspection mode is an image comparison method that was being used when the defect was detected. The inspection mode comprises die comparison, cell comparison and die-cell-mixture comparison. The defect size, the number of defects and the defect size width/height indicate the size of the detected defect. The defect size and width/height are in microns, for example. The number of defect pixels is counted in units of pixels. The defect size ratio represents the ratio of the width and height in the defect size. This is a parameter shown, for example, as 1 when the width and the height are equal to each other, as 2 when the width is twice the height, and so on. The defect portion pixel integrated value represents the derivative of the pixel portion recognized as a defect on the defect image or the reference image, indicating the degree of change in light and shade in the pixel portion. The value of the defect image portion is referred to as the in-defect-image defect portion pixel derivative, while the value of the reference image portion is referred to as the in-reference-image defect portion pixel derivative. The information on kinds of defect is information on kinds of defect obtained as a result of ADC, for example, information on an attachment of a foreign material, a short defect, a scratch, a defect due to a buried foreign material, a void, a pattern shape abnormality, and etching residue.

When defect review with the optical-type or SEM-type device is completed, obtained inspection information is stored in the database 8. FIG. 3 schematically shows the state of defect information stored in the database 8. Referring to FIG. 3, information on various kinds of defect is stored in table form, with defect IDs used as a key. A defect ID field is provided at the left end of the table, and x-coordinate and y-coordinate information fields and a plurality of defect image fields, a first defect image field and a second defect image field, are provided rightward one after another. With respect to a defect with one ID, an image obtained by appearance inspection, an image obtained by optical-type defect review and an image obtained by SEM-type defect review exist. Also, since a plurality of images such as a secondary electron image, a left shadow image and a right shadow image are obtained in SEM-type defect review, it is not rare that the number of defect image fields is ten or more. Since it is difficult in practice to store image data in the table, entry information indicating addresses on the database with which image data is stored is stored in the defect image fields shown in FIG. 3. RDC fields are provided on the right side of the defect image fields. A plurality of groups of RDC information also exist with respect to one defect ID. Therefore the number of RDC information fields corresponding to sorts of RDC information calculated at the appearance inspection and defect review stages are provided.

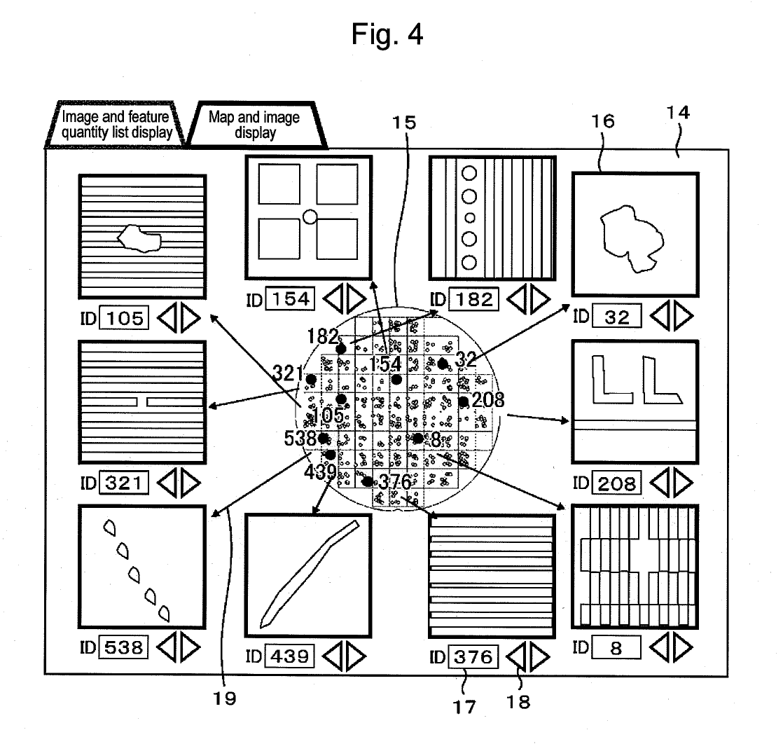

Methods of operating the review report preparation tool implemented in the defect review support device in the present embodiment will be described with reference to FIGS. 4 to 15.

FIG. 4 shows a completed view of a review report prepared by using the review report preparation tool in the present embodiment. The completed view shown in FIG. 4 is a report preparation view displayed on a monitor of the terminal for operating the review report preparation tool. However, if a device user prints out this view or outputs this view to an operation view on presentation software sold on the market, then the immediate result is a review report.

The review report shown in FIG. 4 has a configuration formed of a defect map 15 at a center of a review report preparation view (map and image display view) 14, and a plurality of thumbnail images 16 representing representative examples of detected defects and displayed around the defect map 15. The defect map is constituted of a circle schematically showing a wafer, and dots displayed on the circle and indicating defect positions. Highlighting pointers with which defects thumbnail-displayed are indicated are displayed by being superimposed on dots indicating the defect positions. Arrows 19 indicating the correspondences between the highlighting pointers and the thumbnail images are also displayed. In defect ID input boxes 17 shown below the thumbnail images, numeric values representing defect IDs are displayed. Arrow buttons 18 for scrolling the ID are displayed by the side of each box. The device user can change the defect ID for each thumbnail-displayed defect images by operating the arrow buttons 18.

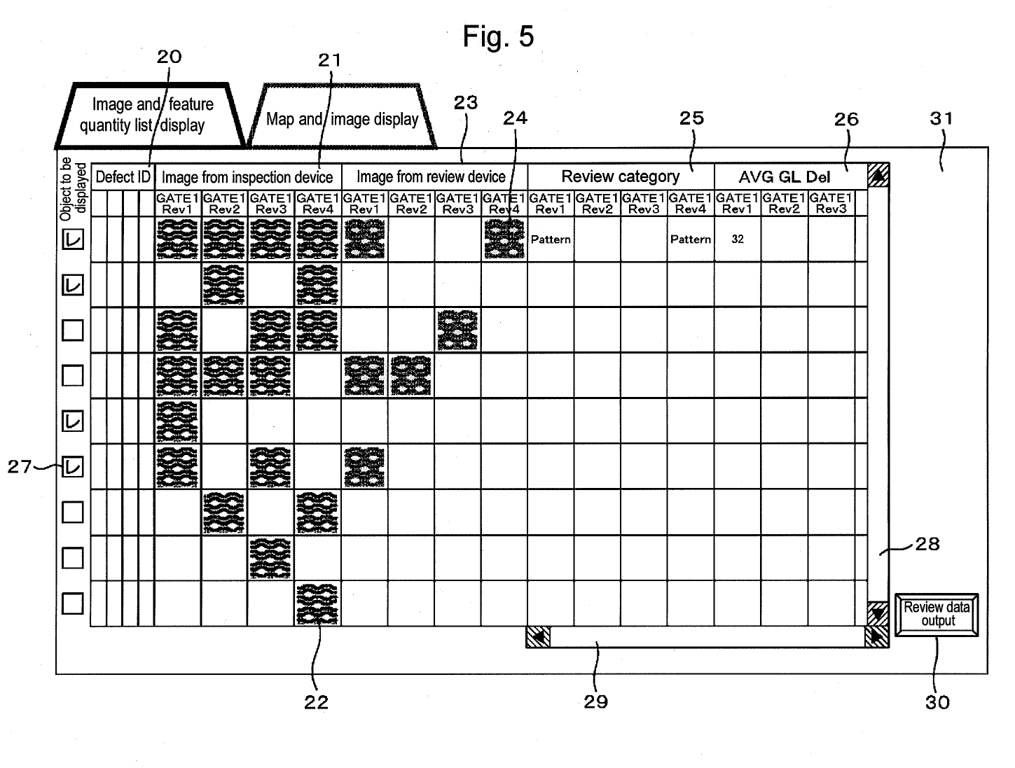

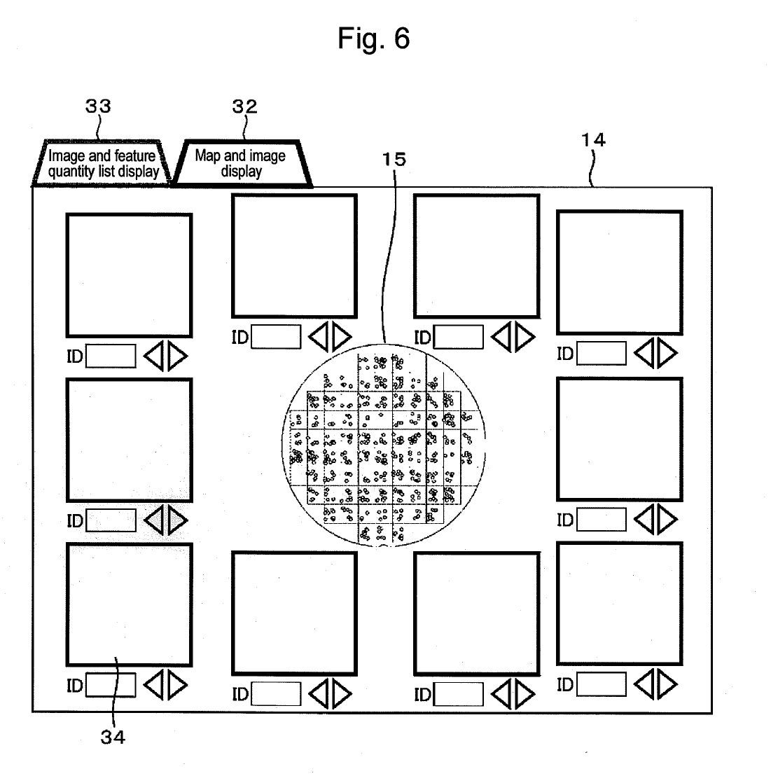

The operation view of the review report preparation tool in the present embodiment will be described with reference to FIGS. 5 and 6. To prepare a review report by referring to review results, the device user first refers to an image and feature quantity list display view 31 shown in FIG. 5.

The image and feature quantity list display view 31 is a view displayed by sorting ADR images and RDC information output from the appearance inspection device or the defect review device with defect IDs and is constituted of a defect ID display section 20 in which defect IDs are displayed, an inspected image display section 21 in which inspection images 22 from the appearance inspection device are displayed, a reviewed image display section 23 in which images 24 obtained by review device are displayed, a review category input and display section 25 in which the IDs for the manufacturing processes on which defect review was performed are displayed, a defect feature quantity display section 26 in which RDC information on detected defects is displayed, and defect selecting buttons 27 for selecting defects to be entered in the review report. Since the number of defects recognized as defects and the amount of RDC information are markedly large, a defect ID scroll bar 28 for moving the on-screen view in defect ID descending/ascending order and a lateral scroll bar 29 are also prepared. By operating the above-described scroll bars, the device user can visually recognize representative defects to be entered in the review report and recognize defect IDs.

Through the image and feature quantity list display view 31 shown in FIG. 5, sorting in ascending or descending order is performed by clicking on the defect ID display section 20. Sorting with respect to the existence/nonexistence of feature quantities or kinds of feature quantity can also be performed by clicking on the defect feature quantity display section 26. This sorting enables instantaneously grasping which kind of defect has which feature quantity. It also enables checking whether a defect is really the one to be found out while recognizing how the defect is seen, or whether or not a defect is a pseudo defect. While in the view shown in FIG. 5 information items relating to one defect ID are displayed by being arranged in the width direction, the information items may alternatively be arranged in the height direction.

In a case where a desired ADR image is not displayed, the defect selecting button 27 is checkmarked and a review data output button 30 shown in FIG. 5 is pressed, thereby transmitting from the terminal 10 (11 or 12) to the database 8 a signal for requesting the defect review image with respect to the defect corresponding to the defect ID checkmarked. The database 8 searches for the review image associated with the defect ID according to the request. If the corresponding review image exists, the database 8 sends back the review image to the terminal side. If the review image associated with the marked ID does not exist, coordinate data corresponding to the ID is produced in the database and sent to the group of optical-type review devices 4 or the group of SEM-type review devices 5 shown in FIG. 1. Simultaneously, a message “inquiring the review device” is transmitted to the terminal side.

When the ID for the defect to be entered in the review report is recognized, the device user sets up a map and image display view 14 shown in FIG. 6. The view shown in FIG. 6 is an initial view of the map and image display view, on which, at the time of review report preparation, defect images to be displayed are successively displayed on the view to progress report preparation. A switch from the image and feature quantity list display view 31 to the map and image display view 14 may be made by clicking on a map and image display view tab 32. Similarly, a change from the on-screen view in FIG. 6 to the on-screen view in FIG. 5 is made by clicking on an image and feature quantity list display view tab 33.

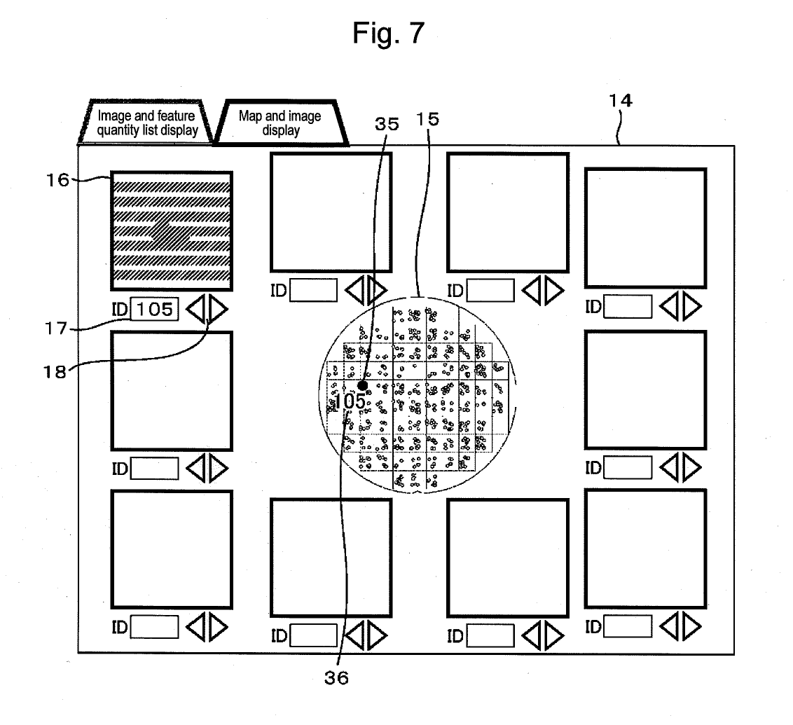

In an initial state, in the review report preparation view shown in FIG. 6, a defect map 15 is displayed in a central portion and a plurality of thumbnail image display boxes 34 are disposed around the defect map 15. In the initial state, the thumbnail image display boxes 34 are blank. In the present embodiment, the number of thumbnail image display boxes 34 is set to 10. The device user first selects a convenient one of the thumbnail image display boxes 34 and inputs a suitable defect ID to the defect ID input box 17. When a return key on a keyboard provided for the terminal 10 (11 or 12) after inputting the defect ID, a thumbnail image of the defect corresponding to the input ID is displayed in the thumbnail image display boxes 34. Since the original images of the ADR images stored in the database and the images obtained by the appearance inspection device are large in size, the thumbnail image is displayed by suitably reducing the resolution from the original image. Simultaneously, the dot displayed on the defect map and indicating the defect corresponding to the ID is highlighted with the highlighting pointer 35, and a numeric value 36 representing the defect ID is displayed in the vicinity of the pointer. FIG. 7 shows an example of an on-screen view in a case where a defect ID “105” is input to the defect ID input box 17 in FIG. 6. A defect image corresponding to the defect ID 105 is displayed in the upper left image display box 33, and the numeric value “105” of the ID is displayed in the defect ID input box 17. Simultaneously, the highlighting pointer 35 is displayed on the dot corresponding to the ID, and the numeric value 36 representing the defect ID is displayed in the vicinity of the pointer. When it is desired to shift the defect to be displayed several points forth or back from the defect ID first selected, the arrow buttons 18 are operated to change the defect ID to a preceding or subsequent one. In a case where one defect exists on a wafer, it is significantly probable that defects of the same kind cluster around the one defect. For preparation of a review report, when it is desired to change the defect highlighting position through a small distance on a defect map, therefore, an operation with the arrow buttons 18 is convenient.

A defect image first obtained by a series of defect inspections is a defect image obtained by the appearance inspection device. Also, images of defects with one ID are stored in the database 8 in time series order in which inspections are made. In the defect review support device in the present embodiment, therefore, a setting is made such that a defect image first displayed after input of a defect ID in the map and image display view shown in FIG. 6 is a defect image obtained by the appearance inspection device. However, it is desirable that image data inserted in a review report be a sharp high-resolution image. Also, since the SEM-type defect review device obtains a plurality of kinds of defect images, it is desirable that the review report preparation tool has a function to easily change the kind of image to be displayed.

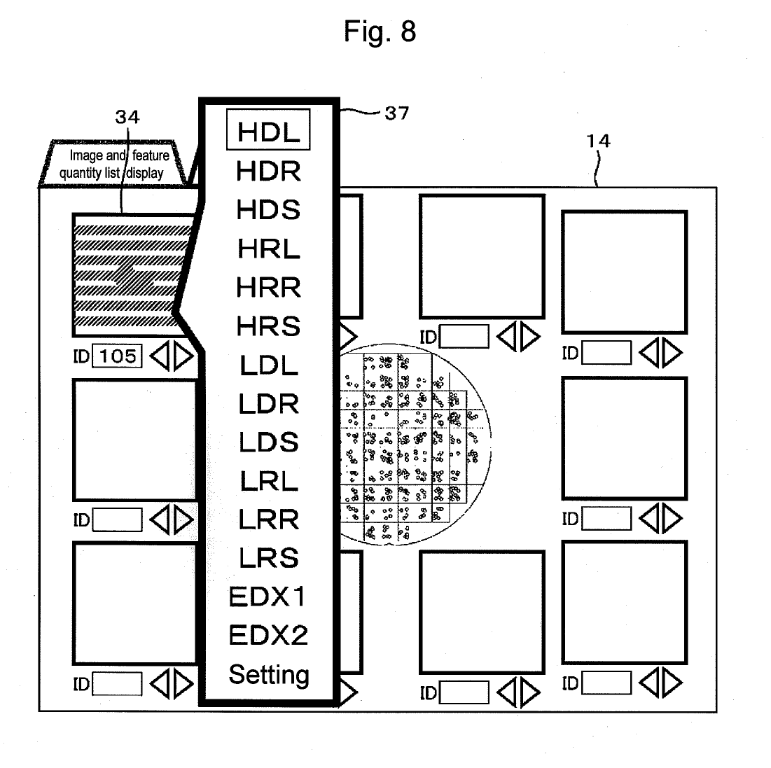

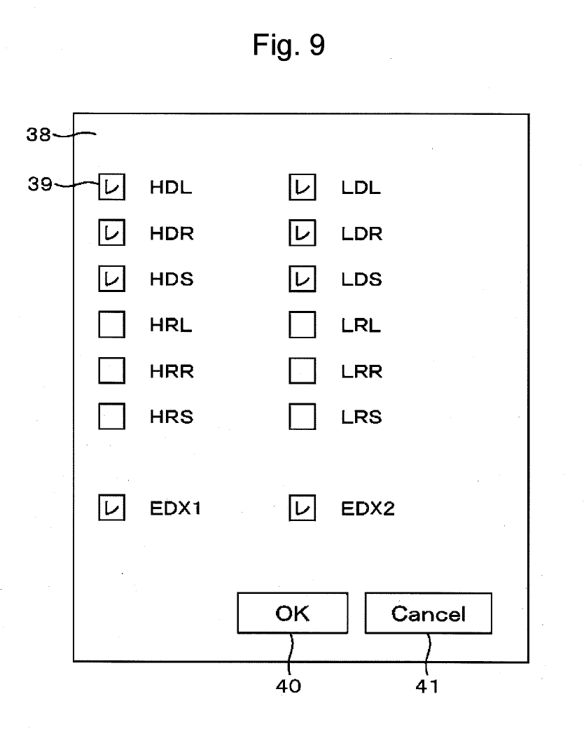

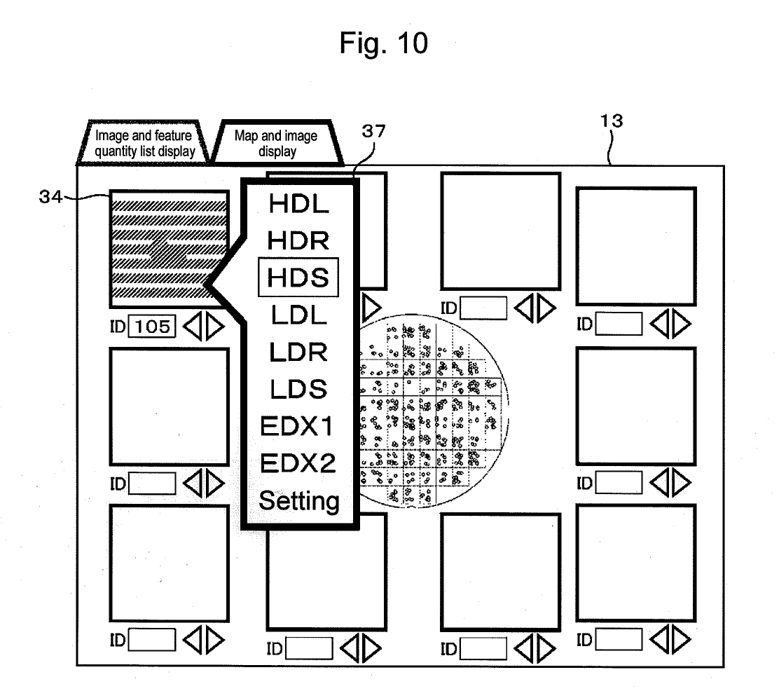

Therefore, the review support device or the review report preparation tool in the present embodiment has a function to select the kind of defect image to be selected through a pull-down menu, which is an example of a review report editing function. When it is desired to change the kind of defect image to be displayed, the device user selects the thumbnail image display box 34 by clicking a right button of a mouse provided for the terminal 10 (11 or 12). A displayed-kind-of-image selecting pull-down menu 37 shown in FIG. 8 is then displayed. The kinds of images displayed in the pull-down menu depend on the kinds of image output from the inspection devices, e.g., the appearance inspection device, the optical-type defect review device and the SEM-type defect review device in the present embodiment, connected to the network 7 shown in FIG. 1. The device user can change the kind of image to be displayed in the review report by selecting a suitable one of the kinds of image in the displayed-kind-of-image selecting pull-down menu 37 displayed. The kinds of image displayed in the displayed-kind-of-image selecting pull-down menu 37 can be selected according to device user's convenience. The displayed-kind-of-image selecting pull-down menu 37 shown in FIG. 8 is a pull-down menu in a default state in which all kinds of defects output from the inspection devices connected to the inspection support device 13. When “Setting” in the displayed-kind-of-image selecting pull-down menu 37 is selected, a window 38 for selecting kinds of image to be displayed in the displayed-kind-of-image selecting pull-down menu, shown in FIG. 9, is displayed. In the window 38 for selecting kinds of image to be displayed in the displayed-kind-of-image selecting pull-down menu, a displayed-kind-of-image selecting button 39, an OK button 40 for confirming a selection and a cancel button 41 for canceling a selection are displayed. The device user selects desired kinds of image to be selected through the displayed-kind-of-image selecting button 39. After confirmation of the selection with the OK button, only the selected kinds of defect images are displayed in the displayed-kind-of-image selecting pull-down menu 37, as shown in FIG. 10. FIG. 10 shows an example in which defect images from the SEM-type review device (with “D” attached in the second place) and EDS analyzed image (EDX1 and EDX2) are selected as kinds of defect image to be displayed.

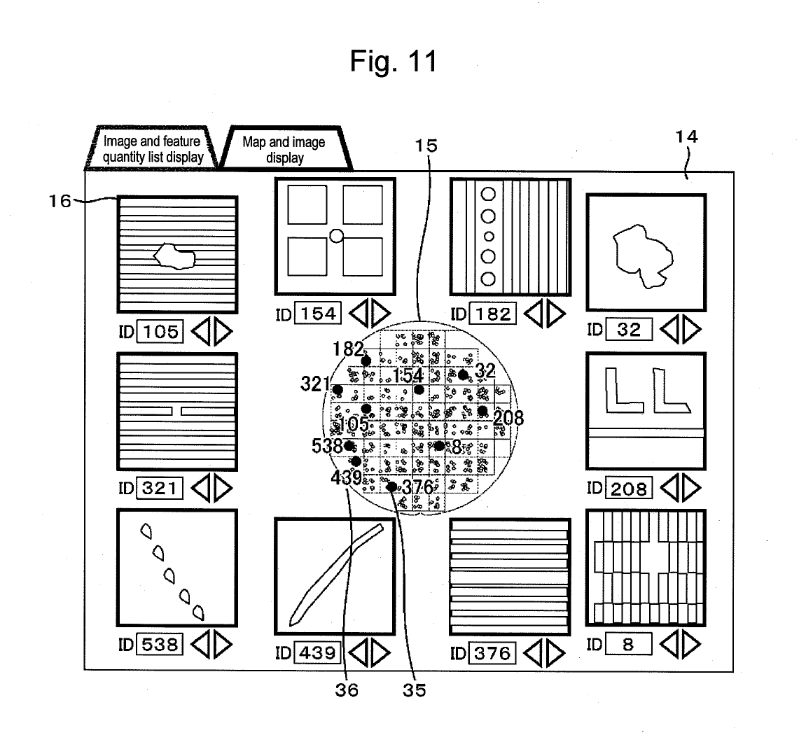

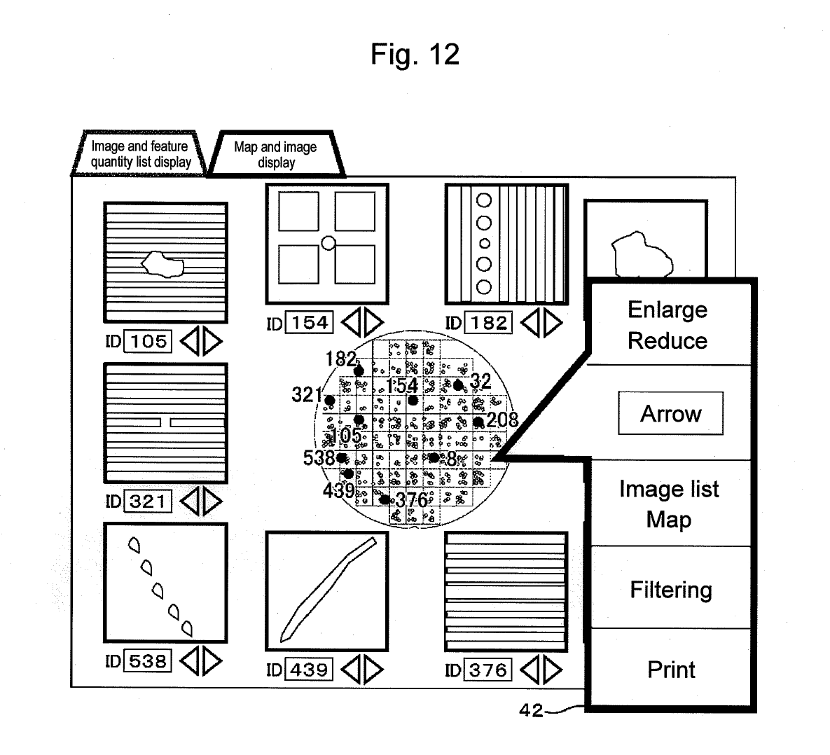

In the above-described way, defect images are successively displayed in the initial view shown in FIG. 6, thereby progressing review report preparation. FIG. 11 shows a view report preparation view (map and image display view 14) in a state immediately before the review report is completed, in which defect images are displayed in all the thumbnail image display boxes 34. In the defect map 15, the highlighting pointers 35 and numeric values 35 of the defect IDs corresponding to the defects displayed in all the image display boxes are displayed. If in this state the mouse is right-clicked on the defect map 15, a display information changing and layout editing pull-down menu 42 shown in FIG. 12 is displayed. When “Arrow” in items displayed in the display information changing and layout editing pull-down menu 42 is selected by mouse right-clicking or the like, arrows connecting the highlighting pointers displayed on the defect map and the thumbnail display boxes 34 are displayed, thereby completing the review report shown in FIG. 4. The arrows may connect the dots and the thumbnail display boxes 34. The completed review report can be printed by selecting “Print” contained in the pull-down menu 41 shown in FIG. 12. The completed review report can alternatively be saved as an electronic data by copy-and-pasting the view shown in FIG. 4 onto presentation software sold on the market.

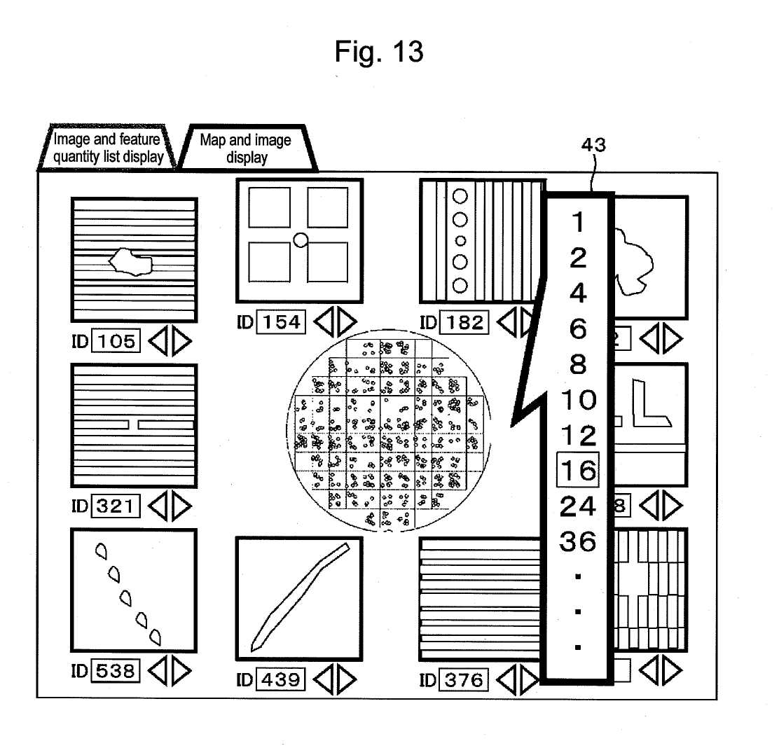

When it is desired to change the number of defect images to be inserted in the review in course of preparation of the review report, the above-described display information changing and layout editing pull-down menu 42 is displayed and “Enlarge” or “Reduce” in the displayed items is selected. When one of the items is selected, a number-of-displayed-image selecting pull-down menu 43 shown in FIG. 13 is displayed.

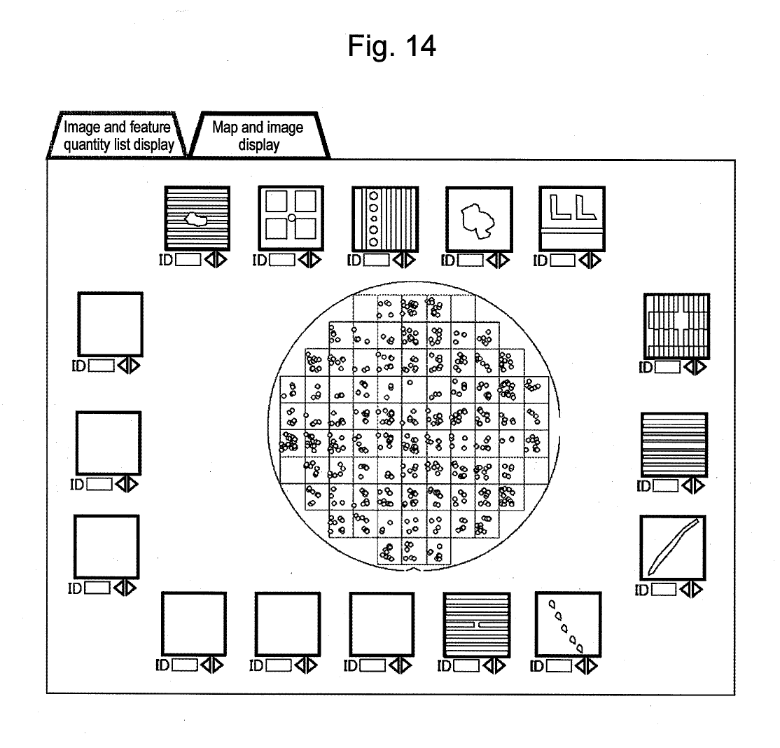

When the device user selects a suitable one of the numeric values contained in the number-of-displayed-image selecting pull-down menu 43, the number of defect images displayed in the map and image display view 14 is changed according to the selected number. FIG. 14 shows a changed view in a case where the number 16 for display is selected in the number-of-displayed-image selecting pull-down menu 43 shown in FIG. 13. Since the number of images to be displayed is changed in course of editing, the added thumbnail display boxes 34 are blank in the map and image display view 14 shown in FIG. 14. The review report preparation process is continued by inputting defect IDs in the defect ID input boxes by the sides of the thumbnail display boxes 34 displayed in the blank state. The above-described operation to change the number of images to be displayed can also be performed at the stage before starting input of defect IDs shown in FIG. 6. In a case where the number of images to be displayed is reduced in course of editing, there is a need to designate which image is to be deleted. In ordinary cases in practice, therefore, “Reduce” in the items displayed in the number-of-displayed-image selecting pull-down menu 43 is used at report preparation initial stage before a start of input of defect IDs. Also, thumbnail images 16 and data in the frame of the defect map 15 displayed on the map and image display view 14 can be freely moved on the view by a drag-and-drop operation using a pointing device such as a mouse, because these kinds of data are object data displayed on the view. In a case where the number of images to be displayed is reduced in course of editing, therefore, an operation to discard in a drag-and-drop manner some of the already-displayed thumbnail images into a trash can icon not shown in the figure may be performed. As described above, the function to set through a pull-down menu the number of images to be displayed and the function to adjust by a drag-and-drop operation the number of images to be displayed are provided in the review report preparation tool to improve the operability of the tool.

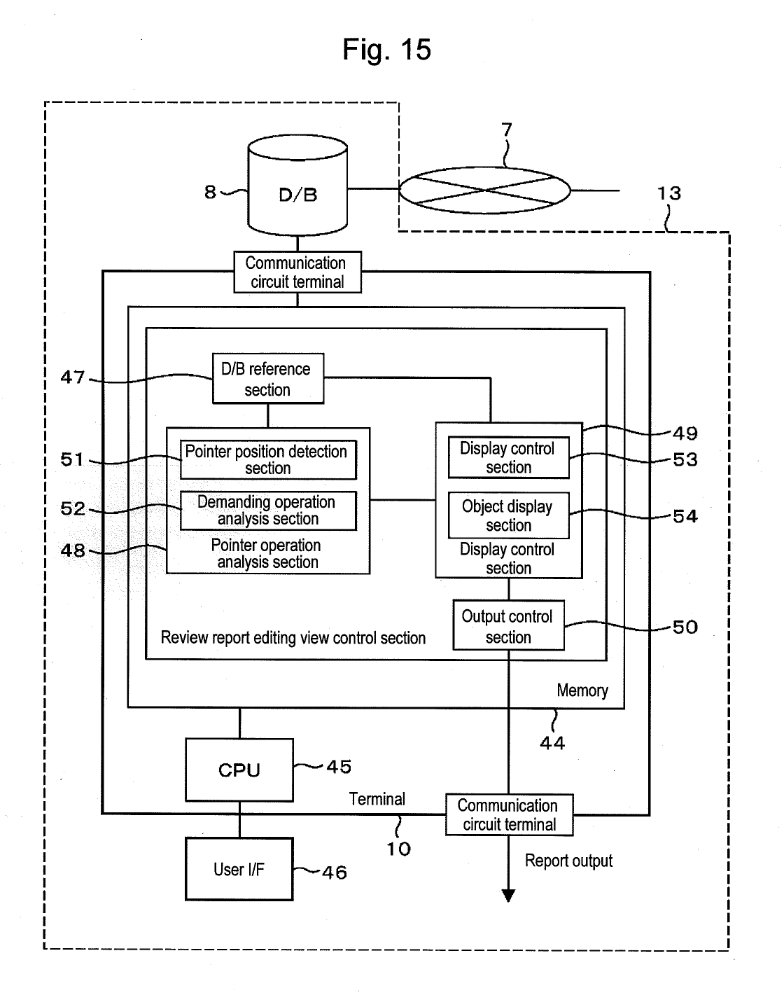

The internal operation of the review support device for realizing the above-described review report editing functions will be described with reference to FIG. 15.

FIG. 15 shows the internal configuration of the terminal 10 in which the review report preparation tool in the present embodiment is implemented. The terminal 10 constitutes the inspection support device 13 along with the database 8 and is connected to the group of appearance inspection devices 3, the group of optical-type review devices 4 or the group of SEM-type review devices 5 via the communication network 7. The terminal 10 is constituted by a memory 44 storing software realizing functional blocks such as shown in the figure, a CPU 45 that executes the software stored in the memory 44, a user interface 46 on which the operation view of the review report preparation tool is displayed, and a communication terminal for connection to the communication network. Devices (e.g., a printing machine and a personal computer) as destinations to which a completed review report is output are also connected via the above-described communication terminal. The user interface 46 is assumed to include input devices such as a keyboard and a mouse as well as the monitor on which the GUI view is displayed. While FIG. 15 is formed as if the functional blocks are realized on the memory, the above-described functional blocks are realized in actuality by the CPU 45 executing a program stored in the memory space.

The functional blocks shown in FIG. 15 are configured by including a database reference section (DB reference section) 46 through which data transmitting and receiving at the time of reference to the database 8 are performed, a pointer operation analysis section 48 that detects the position of an operating pointer mouse-input through the GUI displayed on the review report preparation tool, and that makes analysis as to which instruction the position of the pointer corresponds to, a display control section 49 that performs overall control on the on-screen view on which a GUI display is produced, and an output control section 50 that executes format conversion at the time of output of a prepared review report to an externally connected printing machine or to presentation software sold on the market. The “operating pointer” is an operating pointer displayed on each of the image and feature quantity list display view 31 shown in FIG. 5 and the map and image display view shown in FIG. 6, and used in common on all the GUI views. This pointer is discriminated from the highlighting pointer displayed on the defect map. The pointer analysis section 48 is configured by including a pointer position detection section 51 that detects the position of the operating pointer, and a demanding operation analysis section 52 that analyses the meaning of a mouse-input operation with the operating pointer by referring to the correspondence between information on a position to which the operating pointer is moved and any of the displayed positions of object data GUI-displayed. Also, the display control section 49 is configured by including a map drawing section 53 that produces a GUI display of a defect map, and an object display section 54 that displays object data outside the map circumference, e.g., thumbnail images and various pull-down menus.

For example, in a case where the defect map shown in FIG. 6 is displayed, the map drawing section 53 first transmits a command to the database reference section 47 to obtain information necessary for map drawing. The database reference section 47 selects from the table shown in FIG. 3 the fields necessary for drawing the map shown in FIG. 6, i.e., the database defect ID field, the x-coordinate field, the y-coordinate field and the primary defect image field, to produce packets in the format used in the communication network, and transmits the packets to the database 8. The database 8 sends back the demanded information to the database reference section 47. The database reference section 47 takes the necessary information out of the packet sent back, stores the information in a free space (not shown) in the memory 44 and thereafter sends a memory address at which the data is stored to the map drawing section 53.

The map drawing section 53 converts the obtained information on the x- and y-coordinates of defects into displayed positions on the GUI view and displays the positions on the user interface 46 together with image information representing the wafer (e.g., information on the wafer contour line and rectangle information representing chips). Simultaneously, the object display section 54 displays the thumbnail display sections 34, defect ID input boxes 17 and arrow buttons 18 around the defect map 15. When an ID is input to one of the defect ID input boxes 17, the pointer position detection section 51 detects the occurrence of a certain change in the pointer and interprets the determined position of the pointer to detect the occurrence of the operation for input to the defect ID input box 17. The demanding operation analysis section 52 obtains the information input to the defect ID input box 17 and transmits the information to the object display section 54. The object display section 54 searches for the image data to be displayed on the thumbnail display box 34 by referring to the data downloaded from the database 8 and stored in the memory and by using the defect ID as a key. If the search result is that the image data exists in the memory, the object display section 54 produces image data for a thumbnail image having a suitably reduced resolution from the image data existing in the memory and displays the data by superimposing the data on the thumbnail image display box 34. If the original image data does not exist, the object display section 54 transmits an image obtaining request to the database reference section 47.

On the other hand, the analysis result from the demanding operation analysis section 52 is also transmitted to the map drawing section 53. The map drawing section 53 is thereby enabled to recognize the defect (and the defect ID for the defect) in a state where the ID is input to the defect ID input box 17, and to display the defect highlighting pointer and the defect ID at the corresponding position on the defect map.

When the pull-down menu shown in FIG. 8, 10, or 12 is displayed, the pointer position detection section 51 detects whether or not any mouse operation triggering a pull-down menu display has been performed. Further, the demanding operation analysis section 52 analyzes this mouse operation and transmits the result to the object display section 54. The object display section 54 displays one of the various kinds of pull-down menu according to the transmitted result. The information indicating that the predetermined pull-down menu is being displayed is transmitted to the pointer operation analysis section 48, thereby enabling the pointer position detection section 51 and the demanding operation analysis section 52 to interpret the pull-down menu selecting operation. As described above, view state information held by the pointer operation analysis section 48 having the function to analyze a pointing device such as a mouse and the display control section 49 having the function to display a defect map and various thumbnail images is synchronized with information on the state of a view presently displayed, so that functions to edit a review report layout is realized on the review report preparation view.

When the number of thumbnail images to be displayed is changed through FIG. 13, the displayed size of thumbnail images is automatically changed. Computation processing for changing the displayed size and the displayed position is also executed by the object display section 54.

In actuality, since access to the database 8 occurs before the point in time at which the image and feature quantity list display view 31 shown in FIG. 5 is displayed, a demand for information necessary for displaying FIG. 6 is ordinarily made on the database 8 at that point in time. That is, in ordinary cases, while information on the positions of the defect coordinates is not necessary for displaying the image and feature quantity list display view 31 shown in FIG. 5, information on the positions of the defect coordinates is also obtained before that point in time and all image data on existing defects is downloaded from the database 8 before that point in time and, therefore, there is often no need for demand for images on the database 8 after FIG. 6.

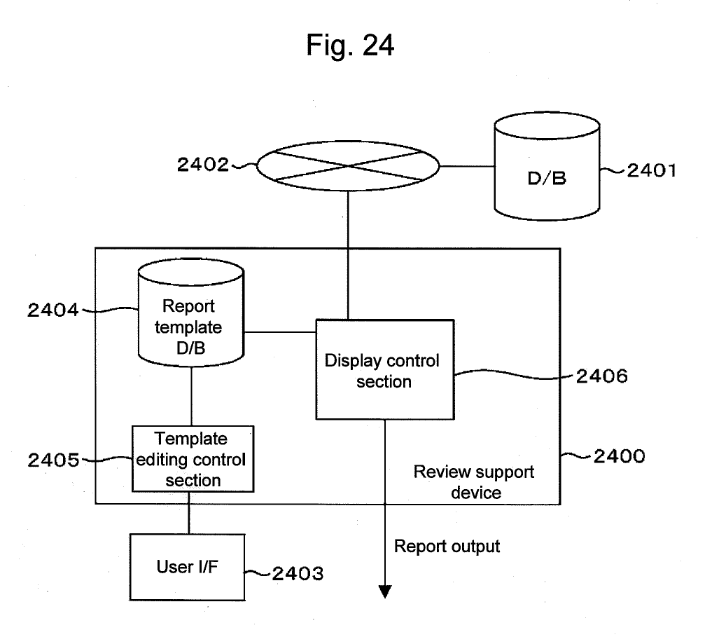

To explain the advantage of the review report preparation tool in the present embodiment, an internal configuration of a terminal or a review support device in which a template-type review report preparation tool is implemented will be described. FIG. 24 shows an internal configuration diagram of a terminal in which a template-type review report preparation tool is implemented. A terminal 2400 shown in FIG. 15 is also connected to a database 2401 via a communication network 2402, as in the terminal 10 in the present embodiment. A device user edits a review report through a user interface 2403 and the edited results are memorized in a report template database 2404 stored in a memory or a hard disk in the terminal. A template editing control section 2405 prepares an on-screen view to be displayed on the user interface 2403. A display control section 2406 prepares a review report by referring to the template memorized in the template database 2404 and by combining information obtained from the database 2401 with the template. For information to be interested in the review report, all relating information items are obtained from the database 2401 on the basis of on information including a wafer ID and a lot number. From this information, the information to be inserted is extracted by referring to the template.

As can be understood from the above description, once a template is determined in the case of the template-type review report preparation tool, adjusting the positions at which thumbnail images and arrows are displayed requires returning to the template editing view to perform the process. The review report layout, however, may be changed according to a device user's intention in the report preparation process. In the case of the template-type review report preparation tool, therefore, there is a need to repeat a complicated process including template editing; confirmation of report view through combined view; and reediting by returning to template editing view, before a completed view for a review report is attained, and a considerably long time is required to prepare a report.

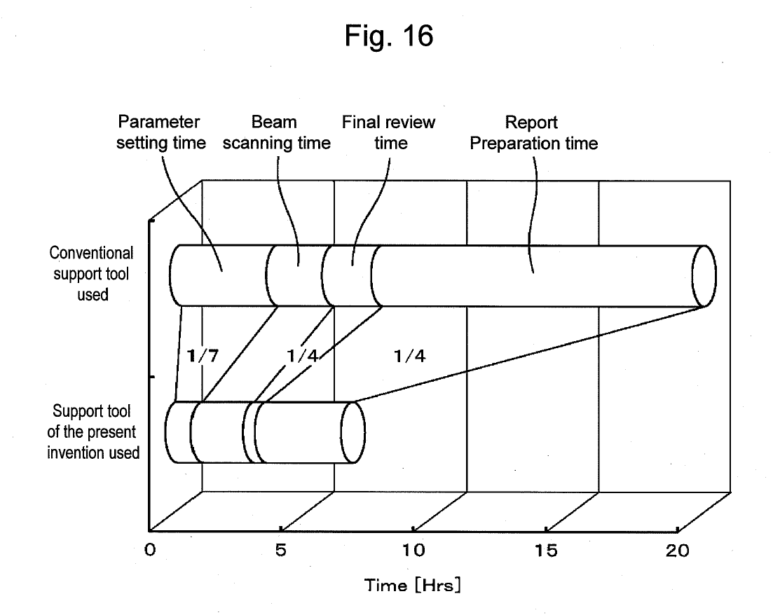

The review report preparation tool in the present embodiment has the editing function that enables changing the review report layout on the review report preparation operation view, thereby largely reducing the number of review report preparation steps. To show the effects of the present embodiment, the time required to prepare a review report in the present embodiment is shown in FIG. 16 in comparison with that in the conventional art. FIG. 16 is a cylinder graph showing the time for review with the defect review device including the report preparation time. The abscissa represents time. It can be understood that the present invention largely reduces the report preparation time to ¼ of the report preparation time in the conventional art.

Thus, the review report preparation tool in the present embodiment enables realization of a review support device facilitating analysis, rearrangement and compilation using a vast amount of image data.

### Embodiment 2

While Embodiment 1 has been described with respect to a review report preparation tool capable of preparing a review report by manually inputting defect IDs, the present embodiment will be described with respect to a configuration of a review report preparation tool further improved in operability.

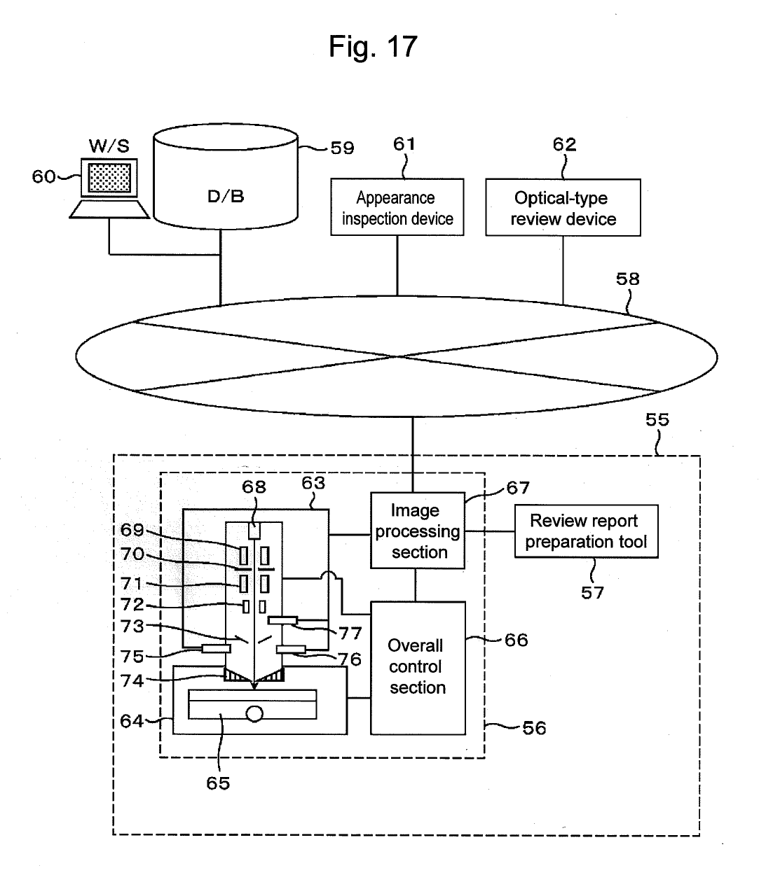

First, FIG. 17 shows an overall diagram showing the relationship between a review support device in which the review report preparation tool in the present embodiment is implemented and devices placed on the periphery of the review support device. A review support device 55 shown in FIG. 17 is constituted by a defect review SEM 56 and a terminal 57 in which the review report preparation tool is implemented. Interconnections are made between the review support device 55, a database 59, an appearance inspection device 61, and an optical-type review device 62 via a communication network 58. Images taken by the appearance inspection device 61, the optical-type review device 62 and the defect review SEM 56 are stored in the database 59 and are read out by the terminal 57 according to one's need, as in the case of Embodiment 1. A workstation 60 has a filter function to extract image information to be stored in the database from images obtained by the appearance inspection device 61, the optical-type review device 62 and the defect review SEM 56, as does that in Embodiment 1. The arrayed structure of data stored in the database 59 is substantially the same as that shown in FIG. 3.

The defect review SEM 56 is constituted by a charged particle optical barrel 63 that applies a primary charged particle beam to a wafer and outputs a secondary charged particle signal generated by application of the primary charged particle beam, a vacuum specimen chamber 64 in which a specimen stage 65 on which a wafer is placed is housed, an overall control section 66 that controls the overall operation of the charged particle optical barrel 63 and the vacuum specimen chamber 64, and an image processing section 67 that sorts obtained defects by using taken images. The charged particle optical barrel 63 is constituted by an electron source 68 that generates a primary electron beam, upper and lower condenser lenses 69 and 71 and a beam current diaphragm 70 for controlling the beam current rate of the electron beam generated in the electron source, a scanning deflector 72 that scans the specimen with the electron beam, a reflector plate 73 that reflects out of the optical axis secondary charged particles generated by application of the primary electron beam, an objective lens 74 that converges onto the specimen the electron beam moved for scanning by the scanning deflector, a left shadow image detector 75 that detects backscattered electrons reflected on the left-hand side as viewed on the plane of projection of the figure in the secondary charged particles reflected by the reflector plate, a right shadow image detector 76 that detects backscattered electrons reflected on the right-hand side as viewed on the plane of projection of the figure, and a secondary electron detector 77 that outputs a secondary electron image formation signal.

The image processing section 67 obtains IDs for defects not having undergone defect review and defect position information about the defects by referring to the database 59. In some case, these defect IDs and defect position information are directly transmitted from the appearance inspection device 61. The internal configuration of the terminal 57 is the same as that described with reference to FIG. 15, and the description for it will not be repeated.

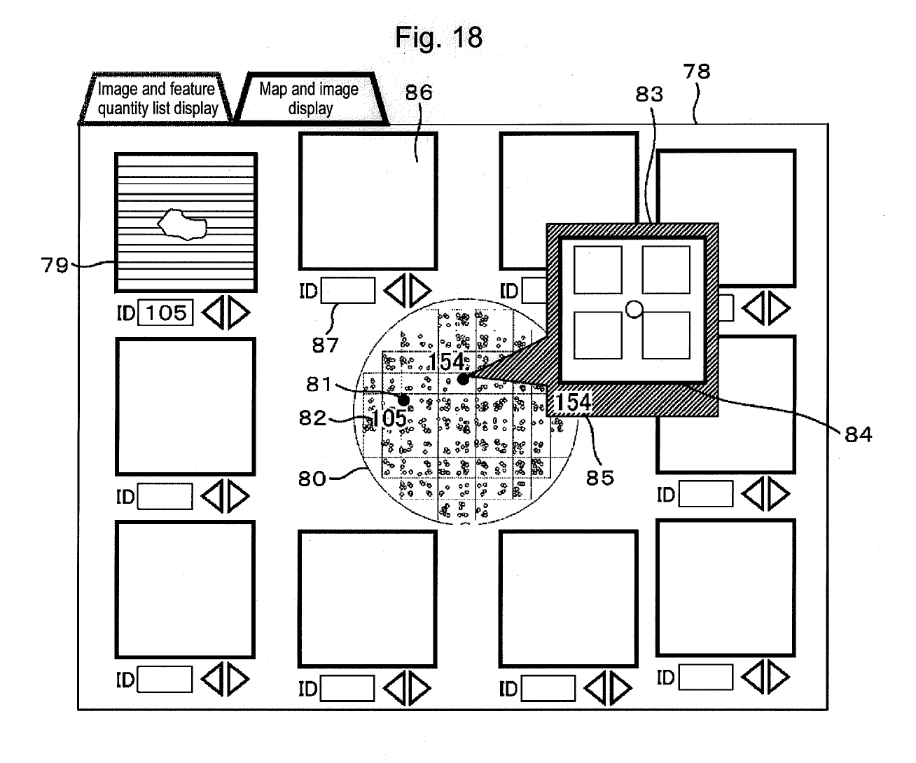

An operation view of the review report preparation tool in the present embodiment will be described with reference to FIGS. 6, 18, and 19. For ease of description, a completed view for a review report is assumed to be the same as the view shown in FIG. 4. A device user first causes an initial view of a review report preparation view to be displayed. The initial view is the same as the initial view in Embodiment 1 shown in FIG. 6. In the present embodiment, when the operating pointer is put on the defect map displayed in the initial view of the review report preparation view (the pointer is moved onto a dot on the defect map with a pointing device such as a mouse), a balloon view in which a thumbnail image of a corresponding defect and a defect ID are displayed is displayed. For example, in FIG. 18, a map and image display view 78 is shown in a state where the above-described balloon view is displayed. Referring to FIG. 18, a first thumbnail image 79 corresponding to a defect with an ID “105” is already displayed and the position of the defect with the ID “105” is highlighted with a highlighting pointer 81 on a defect map 80. The numeric value “105” is also displayed as a defect ID 82 in the vicinity thereof.

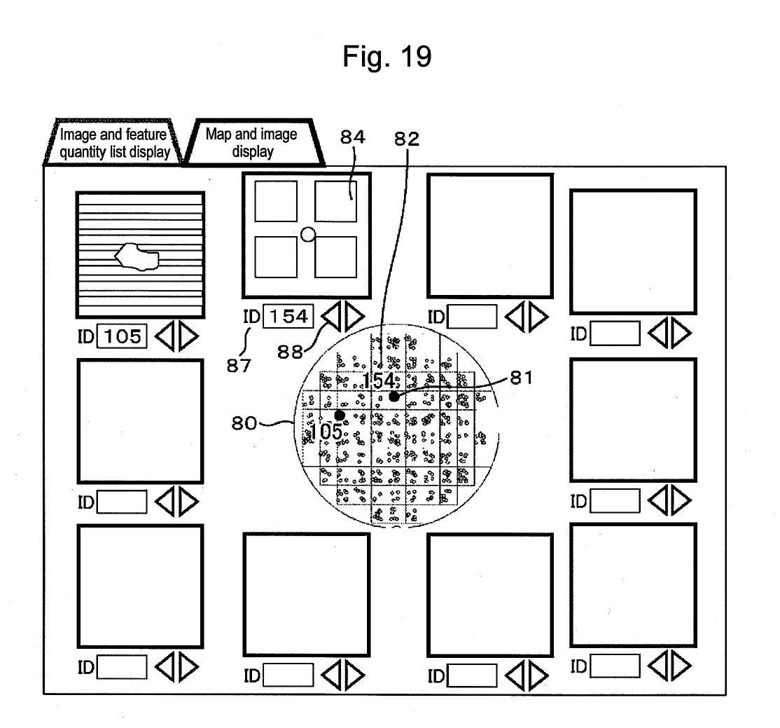

When the device user puts the operating pointer on a suitable dot on the defect map to select a thumbnail image to be next displayed, a balloon view 83 containing a second thumbnail image 84 and a defect ID 85 is displayed in a pop-up manner. The device user performs an operation to drag and drop the second thumbnail image 84 displayed in the balloon view 83 into a desired image display box 86 in a plurality of image display boxes displayed in the map and image display view 78 by operating a pointing device such as a mouse. In this way, the second thumbnail image 84 displayed in the balloon view 83 can be pasted in the image display box 86. Simultaneously, the defect ID corresponding to the drag-and-dropped defect image is automatically displayed in an ID input box 87 below the image display box 86. Also, on the defect map 80, the defect position corresponding to the selected thumbnail image is highlighted with the highlighting pointer 81, and the defect ID value “154” is also displayed. FIG. 19 shows an on-screen view immediately after the second thumbnail image is drag-and-dropped from the balloon view 84 in FIG. 18.

When one of the arrow buttons 88 by the side of the defect ID input box 87 is pressed, the defect ID value displayed in the defect ID input box 87 is changed according to the number of times the button is pressed. Simultaneously, the image displayed in the image display box 86 and the displayed position of the highlighting pointer 81 displayed on the defect map 80 are changed according to the change of the ID.

When one thumbnail image displayed in the map and image display view 78 is deleted, a drag-and-drop operation to move the image into a trash can icon not shown in the figure by clicking on the image is performed. Also, the image display positions can be interchanged by drag-and-dropping one of the defect images to another of the defect images.

In the above-described way, the operating pointer is moved on the defect map to successively display balloon images and successively paste desired thumbnail images, thereby progressing review report preparation.

The internal operation in the terminal 57 in the present embodiment will be described with reference to FIG. 15. The operation in the terminal at the time of displaying a defect map and thumbnail images is the same as that in Embodiment 1. Description is then made here of the internal operation at the time of performing a copy-and-paste operation on an image displayed on a balloon view.

When the operating pointer is moved onto an arbitrary dot in the defect map shown in FIG. 18 by the device user performing a pointing device operation, the pointer position detection section 51 detects the present displayed position of the operating pointer and transmits this position to the demanding operation analysis section 52. The demanding operation analysis section 52 detects the coincidence between the transmitted present displayed position of the operating pointer and the displayed position of the dot displayed on the defect map 80, and interprets this as a demand for display of the balloon view 83. Further, the demanding operation analysis section 52 transmits the analysis result “demand for display” to the display control section 49 together with information on the defect ID value. The map drawing section 53 produces a pop-up display of the above-described balloon view 83 in the vicinity of the dot corresponding to the transmitted defect ID and simultaneously displays the highlighting pointer 81. The object display section 54 displays a thumbnail image and the detect ID value as object data in the pop-up-displayed balloon view 83.

Next, when the thumbnail image, which is object data displayed in the balloon view 83, is drag-and-dropped into the image display box 86, the pointer position detection section 51 detects this operation and transmits this operation to the demanding operation analysis section 51. The demanding operation analysis section 51 interprets this drag-and-drop operation as an operation to paste the defect image with the defect ID 154 in the image display box 86 and transmits this to the display control section 49. The object display section 54 displays the defect image with the defect ID 154 in the image display box 86 and also displays the defect ID value “154” in the defect ID input box 87. The balloon view 83 is maintained in the displayed state unless the operating pointer is moved from the position of the defect ID 154. However, the device may be configured so that when the time period during which no operation on the operating pointer occurs reaches or exceeds a certain length of time, a timeout occurs and display of the balloon view 83 is terminated.

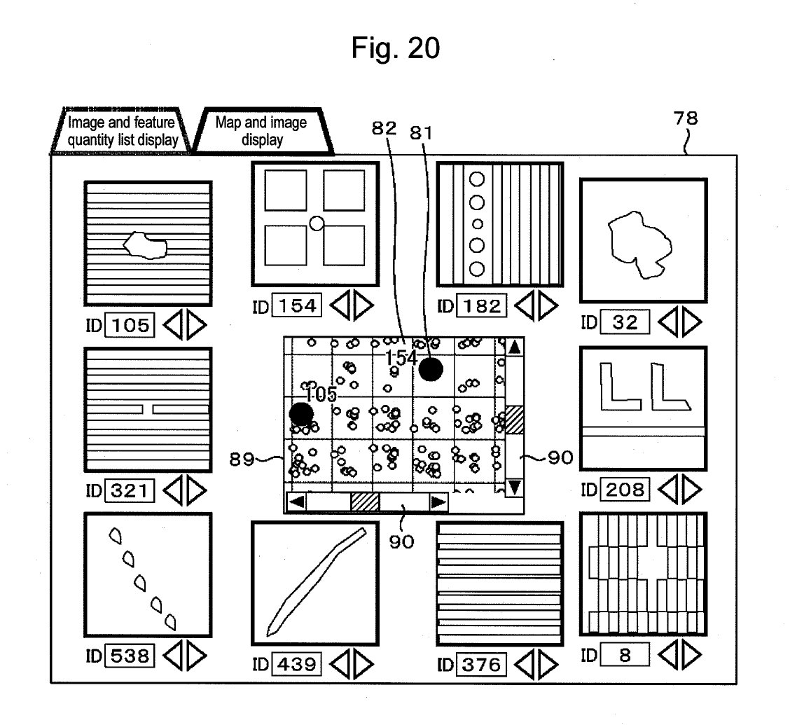

If the number of dots displayed on the defect map is large, there is a possibility of a hindrance to selection of the dots performed by moving the operating pointer on the defect map. The review report preparation tool in the present embodiment has a function to produce an enlarged display of a portion of the defect map in such a situation. The device user can select a defect to be displayed in thumbnail form from a region displayed by being enlarged. To produce an enlarged display of the defect map, the device user moves the operating pointer into a suitable region on the defect map 80 where no dot is displayed, and operates the pointing device (e.g., right-clicks the mouse). A display information changing and layout editing pull-down menu 42, such as shown in FIG. 12 in Embodiment 1, is then displayed. When “Enlarge” in the displayed items is displayed, an enlarged diagram of the defect map, such as shown in FIG. 20, is displayed at a center of the map and image display view 78. Even when displayed by being enlarged, the highlighting pointer 81 and information on the defect ID value displayed in the defect ID input box 87 are displayed in an enlarged defect map diagram 89 without being changed. Enlarged map display position moving scroll bars 90 are also displayed along with the enlarged defect map diagram 89 for the purpose of moving the displayed position of the enlarged defect map diagram 89. *Please give a suitable name to this yellow-marked portion (a scroll bar for something). When the original size of the defect map is restored from the enlarged size of the defect map in the enlarged display, the display information changing and layout editing pull-down menu 42 may be displayed again by operating the mouse and “Reduce” may be selected from the displayed items.

In the map and image display view 78, an image list 91 can be displayed in place of the defect map. In the “image list”, defect images corresponding to all the dots displayed in the defect map 80 are displayed by being arranged in order of defect IDs. Since a plurality of kinds of defect image exist with respect to one defect ID as shown in FIG. 3, a plurality of defect images associated with one ID are contained in the defect images displayed in the “image list”.

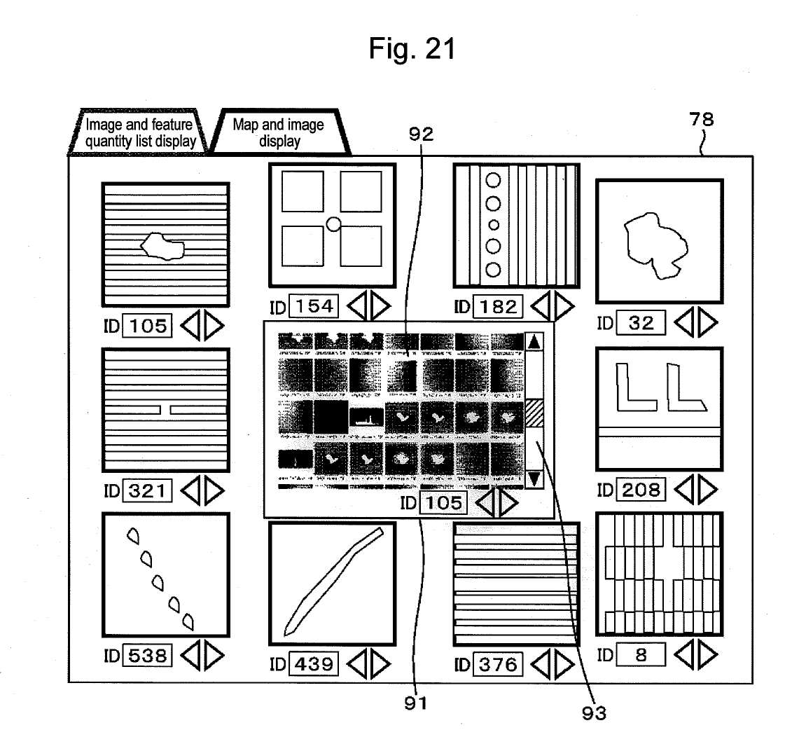

To display the image list, a display information changing and layout editing pull-down menu 42, such as shown in FIG. 12, is selected by operating the pointing device and “Image list” in the displayed items is selected by operating the pointing device. FIG. 21 shows the map and image display view 78 in a state where an image list is displayed. In the image list 91 shown in FIG. 21, the defect image with the defect ID input to the defect ID input box 87 is in a highlighted display 92, and the device user can instantly grasp which image is displayed in thumbnail form. Also, the defect images displayed in the image list 91 can be slid by operating a scroll bar 93 for making display screen selections. The device user can display the desired defect image in thumbnail form in the desired image display box by selecting the desired image from the defect images displayed in the image list 91 and by drag-and-dropping the image into the image display box. This drag-and-drop operation is effective irrespective of whether the image display box is blank or a thumbnail image is already displayed in the image display box. When a switch from the image list display to the defect map display is made, a display information changing and layout editing pull-down menu 42, such as shown in FIG. 12, is called up and “Map” is selected from the displayed items to make a switch to the defect map display.

Each of the above-described various operations, e.g., a defect map enlarging/reducing operation, display of a list of defect images, or display of a pull-down menu is realized by the pointer operation analysis section 48 shown in FIG. 15, detecting and analyzing the operation of the operating pointer with a mouse, and transmitting the result to the display control section 49.

As described above, switching between thumbnail image selection by means of a defect map and thumbnail image selection by means of an image list ensures compatibility between the facility with which a defect distribution is grasped by means of the defect map and the visibility of defect image configurations by means of the image list. The operability at the time of review report preparation is further improved in comparison with the case where only one of them can be displayed.

Further, an operation to display a defect image corresponding to a desired defect ID even in an image display box in which a thumbnail image is already displayed can be performed by inputting the defect ID in the defect ID input box 87, as in the case of Embodiment 1. In the review report preparation tool in the present embodiment, therefore, the device user can selectively use the two selection methods: thumbnail image selection by manual input of a defect ID in one defect ID input box 87; and thumbnail image selection by an operation to drag-and-drop an image from an image list. As a result, the convenience for extraction and selection of suitable images to be shown in a report is improved; the time taken to prepare a report including necessary information is further reduced; and the time before an improvement in yield is achieved is reduced.

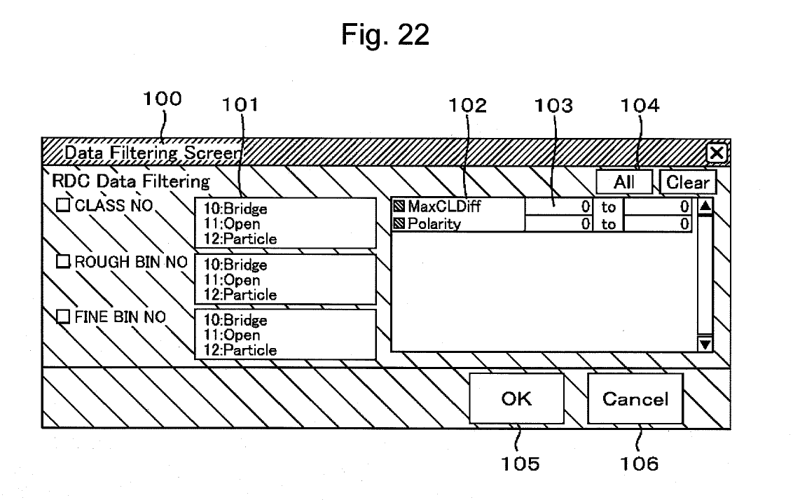

FIG. 22 shows a data filtering window 100 for narrowing down defect images to be displayed in an image list display. This view is displayed as a pop-up window from “map and image display view 78” by selecting the item “Filtering” contained in the display information changing and layout editing pull-down menu shown in FIG. 12. In the data filtering window 100 shown in FIG. 22, a kinds-of-defect window 101 in which information on kinds of defect is displayed and an RDC window 102 in which defect feature quantity information other the information on kinds of defect is displayed, for example, are displayed. The device user selects a defect of a desired kind from the kinds-of-defect list displayed in the kinds-of-defect window 101 by using an input device such as a mouse or a keyboard, or inputs a suitable value to a defect feature quantity input section 103 displayed in the RDC window 102. For example, to a “MaxGIDiff” input section (maximum gray level difference input section), a gradation value of a suitable gray level difference is input. To a “Polarity” input section, a plus or minus sign is input. When a confirmation button 105 is thereafter pressed, only defect images corresponding to the kind of defect selected by the device user or the RDC information are displayed in the image list shown in FIG. 21. When a “Select all” button 104 is pressed, all defect images are selected. In the case of the defect map, only dots corresponding to the defects corresponding to the kind of defect selected by the device user or the RDC information are displayed on the defect map. When a cancel button 106 is pressed, the setting is canceled.

As described above, a function to set conditions for selection of RDC information is provided in the review report preparation view to enable kinds of defect images to be displayed on the GUI view to be narrowed down according to a review preparer's intention, thus enabling finding a defect to be shown in a review report in a short time with ease. The above-described display control is also realized by cooperative processing performed by the pointer operation analysis section 48 and the display control section 49 shown in FIG. 15.

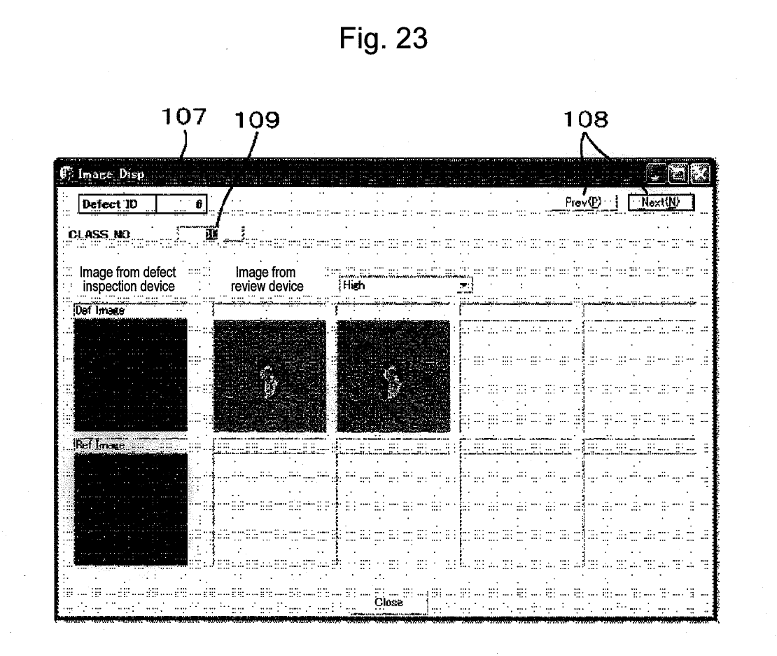

In some cases, it is desired to display an enlarged image of some of the thumbnail images shown in FIGS. 18 to 21. This is because with respect to a minuscule defect there is ordinarily a demand for checking the defect by enlarging the image so that defect portions are largely displayed. In such a case, a double click is made on the thumbnail image. An image enlarging display and kind-of-defect code input window 107 shown in FIG. 23 is thereby displayed to enable the thumbnail image displayed on the review report preparation view (map and image display view 78) to be checked in an enlarged image with high resolution. Slide buttons 108 are also displayed in the image enlarging display and kind-of-defect code input window 107. Buttons “Prey” and “Next” shown as slide buttons 108 are operated to change the displayed defect image according to the defect ID.

As described in Embodiment 1, thumbnail images are displayed by suitably reducing the resolution from the original images. When the image enlarging display and kind-of-defect code input window 107 is called up by the above-described double click, therefore, the pointer operation analysis section shown in FIG. 15 computes the ID for the selected defect from the position information on the double-clicked map and image display view 78, and transmits the ID to the object display section 54. The object display section 54 produces a display on the image enlarging display and kind-of-defect code input window 107 without reducing the resolution, by referring to the data of the defect image stored in a free space in the memory 44 on the basis of the transmitted defect ID information.

As shown in FIG. 23, all the defect images having the defect IDs selected by double-clicking are displayed on the image enlarging display and kind-of-defect code input window 107. When it is desired to narrow down the defect images to be displayed, the defect images to be displayed on the image enlarging display and kind-of-defect code input window 107 can be selected by inputting code information indicating the kinds of defect to a kind-of-defect code input section 109 displayed on this window. When one of the slide buttons 108 is operated in this state, the displayed defect images are also changed according to the defect ID. In this way, check of minuscule defects is facilitated and the time taken to visually check defects can be reduced.

The description has been made by assuming that the review support device is constituted by a defect review SEM and a review report preparation terminal connected to the defect review SEM. However, the method of review report preparation by means of a drag-and-drop operation in the present embodiment can also be applied to an inspection support device or a review support device constituted by a database and a review report preparation terminal, as shown in FIG. 1.

### REFERENCE SIGNS LIST

1 Clean room

2 Semiconductor manufacturing apparatus

3 Group of appearance inspection devices

4 Group of optical-type review devices

5 Group of SEM-type review devices

6 Inspection device

7, 58 Communication network

8, 59 Database

9, 60 Workstation

10 to 12, 57 Terminals

13 Defect inspection support device in Embodiment 1

14 Map and image display view in Embodiment 1

15, 80 Defect map

16 Thumbnail image

17, 87 Defect ID input box

18, 88 Arrow button

19 Arrow

20 Defect ID display section

21 Inspected image display section

22 Inspection image from appearance inspection device

23 Reviewed image display section

24 Image obtained by review device

25 Review category input and display section

26 Defect feature quantity display section

27 Defect selecting button

28 Defect ID scroll bar

29 Lateral scroll bar

30 Review data output button

31 Image and feature quantity list display view

32 Map and image display view tab

33 Image and feature quantity list display view tab

34 Thumbnail image display boxes

35, 81 Highlighting pointer

36 Numeric value representing defect ID

37 Displayed-kind-of-image selecting pull-down menu

38 Window for selecting kinds of image to be displayed in displayed-kind-of-image selecting pull-down menu

39 Displayed-kind-of-image selecting button

40 OK button

41, 106 Cancel button

42 Display information changing and layout editing pull-down menu

43 Number-of-displayed-image selecting pull-down menu

44 Memory

45 CPU

46 User interface

47 Database reference section

48 Pointer operation analysis section

49 Display control section

50 Output control section

51 Pointer position detection section

52 Demanding operation analysis section

53 Map drawing section

54 Object display section

55 Defect Review support device in Embodiment 2

56 Defect review SEM

61 Appearance inspection device

62 Optical-type review device

63 Charged particle optical barrel

64 Vacuum specimen chamber

65 Specimen stage

66 Overall control section

67 Image processing section

68 Electron source

69 Upper condenser lens

70 Beam current diaphragm

71 Lower condenser lens

72 Scanning deflector

73 Reflector plate

74 Objective lens

75 Left shadow image detector

76 Right shadow image detector

77 Secondary electron detector

78 Map and image display view in Embodiment 2

79 First thumbnail image

82, 85 Defect ID

83 Balloon view

84 Second thumbnail image

86 Image display box

89 Enlarged defect map diagram

90 Enlarged map display position moving scroll bar

91 Image list

92 Highlighted display

93 Displayed image selecting scroll bar

100 Data filtering window

101 Kinds-of-defect window

102 RDC window

103 Defect feature quantity input section

104 “Select all” button

105 Confirmation button

107 Image enlarging display and kind-of-defect code input window

108 Slide button

109 Kind-of-defect code input section

1-14. (canceled)

15. A review support device used by being connected to a defect review device having a function to review a plurality of defects existing in a specimen to be inspected, the review support device comprising:
a communication circuit terminal to which a communication circuit connected to an appearance inspection device or an observation device is connected, and through which position information and image information about the plurality of defects are taken in;
an information processor which processes the position information and the image information about the defects; and
a monitor on which results of processing by the information processor are displayed,
wherein a review report preparation view is displayed on the monitor, the review report preparation view including a defect map indicating the positions of the plurality of defects on the specimen to be inspected, thumbnail images of at least two of the plurality of defects displayed around the defect map, identifier information items respectively corresponding to the at least two defects, and an operating pointer for designating the defect map, the thumbnail images or the identifier information items, and
the thumbnail images are displayed in the review report preparation view so that the positions at which the thumbnail images are disposed on the monitor can be changed independently of each other.

16. The review support device according to claim 15, wherein the defect positions on the defect map corresponding to the thumbnail images of the review report preparation view are highlighted, and identifier information corresponding to the defects at the highlighted positions is displayed in the vicinities of the positions of the highlighted defects.

17. The review support device according to claim 15, wherein arrows connecting the defects displayed on the defect map and the thumbnail images of the defects are displayed in the review report preparation view.

18. The review support device according to claim 15, wherein a list of images at the defect positions indicated on the defect map can be displayed in place of the defect map of the review report preparation view.

19. The review support device according to claim 15, wherein in response to a designation with the operating pointer, a pull-down menu for changing the number of thumbnail images to be displayed in the review report preparation view is displayed.

20. The review support device according to claim 15, wherein the size of the thumbnail images in the review report preparation view is changed according to a change in the number of thumbnail images.

21. The review support device according to claim 15, wherein a function to enlarge or reduce the displayed size of the defect map or thumbnail images in the review report preparation view is provided.

22. The review support device according to claim 15, wherein a change button for changing the identifier information items is displayed.

23. The review support device according to claim 15, wherein when the pointer is moved onto one of the thumbnail images, a pull-down menu for selection among a plurality of defect images taken by different methods is displayed on the review report preparation view.

24. The review support device according to claim 15, wherein a setting button for adjusting the kinds of defect images contained in the pull-down menu is also displayed in the pull-down menu.

25. The review support device according to claim 15, wherein when the pointer is moved to one of the defect positions displayed on the inspection map, the defect image corresponding to the defect to which the pointer is moved is balloon-displayed.

26. The review support device according to claim 15, wherein the balloon-displayed defect image can be dragged and dropped to a thumbnail image display position with the pointer to display the defect image at the thumbnail image display position.

27. The review support device according to claim 15, wherein a list operation view in which original images of the thumbnail images are displayed in order of the identifiers can be displayed on the monitor.

28. The review support device according to claim 15, wherein the communication circuit terminal is a communication circuit terminal connectable to a printing machine, and a printing button for commanding the printing machine to print the review report preparation view can be displayed on the review report preparation view.
